(19) United States
(12) Patent Application Publication
(10) Pub. No.: US 2024/0409006 A1
(43) Pub. Date: Dec. 12, 2024

(54) ELECTRIC VEHICLE WITH BATTERY THERMAL MANAGEMENT SYSTEM

(71) Applicant: 9351-0618 QUÉBEC INC., Sherbrooke (CA)

(72) Inventors: Mahmoodreza SALIM SHIRAZY, Boucherville (CA); Luc FRECHETTE, Sherbrooke (CA); Jérémy MORIOT, Sherbrooke (CA)

(21) Appl. No.: 18/735,260

(22) Filed: Jun. 6, 2024

Related U.S. Application Data
(60) Provisional application No. 63/507,566, filed on Jun. 12, 2023.

(51) Int. Cl. B60L 58/26; B60K 11/02; B60L 50/60; H01M 10/48; H01M 10/613; H01M 10/625; H01M 10/63; H01M 10/6551; H01M 10/6554; H01M 10/6556; H01M 10/6563; H01M 10/6568; H01M 50/249

(52) U.S. Cl. CPC B60L 58/26; B60K 11/02; B60L 50/60; H01M 10/486; H01M 10/613; H01M 10/625; H01M 10/63; H01M 10/6551; H01M 10/6554; H01M 10/6556; H01M 10/6563; H01M 10/6568; H01M 50/249; H01M 2220/20

(57) ABSTRACT

A thermal management system for an electric vehicle is disclosed, and includes a heat sink located within a cavity of a frame of the vehicle's chassis, and a heat-conducting plate having an evaporator section and a condenser section. The evaporator section of the heat-conducting plate is in heat exchange relationship with one of a battery mounted on the frame of the electric vehicle and the heat sink. The condenser section of the heat-conducting plate is in heat exchange relationship with the other of the battery and the heat sink.

### CROSS-REFERENCE TO RELATED APPLICATIONS

The present application claims priority on U.S. Provisional Patent Application No. 63/507,566 filed Jun. 12, 2023, the entire contents of which are incorporated by reference herein.

### TECHNICAL FIELD

This disclosure generally relates to electric vehicles having batteries supplying motive power to the vehicle and, more particularly, to the thermal management of such batteries.

### BACKGROUND

Electric vehicles and other types of electric equipment may be powered by one or more electric batteries. Each battery typically includes a plurality of cells that are operatively connected to one another. Such batteries generate heat when power is drawn from them and to them. In some cases, operating batteries when temperatures of the batteries exceeds a maximum temperature threshold may impede their performance and, in some cases, may damage the batteries. Hot ambient temperatures may also contribute to elevated battery temperatures. Additionally, performance of the batteries may decrease when they are operated at a temperate below a minimum temperature threshold. While attempts to better regulate the temperature of batteries have been made, improvements are nonetheless sought.

### SUMMARY

In accordance with one aspect of the present disclosure, there is provided an electric vehicle, comprising: a chassis including a frame having a frame member, the frame member enclosing a cavity such as to be at least partially hollow; an electric motor mounted to the frame; a battery mounted to the frame and operatively connected to the electric motor to provide motive power to the electric vehicle; and a thermal management system having: a heat sink located within the cavity of the frame member, and a heat-conducting plate having an evaporator section and a condenser section, the evaporator section of the heat-conducting plate being in heat exchange relationship with one of the battery and the heat sink, and the condenser section of the heat-conducting plate being in heat exchange relationship with the other of the battery and the heat sink.

The electric vehicle as defined above and described herein may also include any one or more of following features, in whole or in part, and in any combination. In some embodiments, the heat-conducting plate is U-shaped.

In some embodiments, the frame includes the frame member and a second frame member, and a web connecting the frame member with the second frame member, the battery mounted on the web.

In some embodiments, the evaporator section overlaps the web, the condenser section including two condenser sections each protruding from the evaporator section and being disposed adjacent a respective one of the frame member and the second frame member.

In some embodiments, the two condenser sections transversally protruding from the evaporator section.

In some embodiments, the two condenser sections are parallel to the evaporator section and protrude from opposite sides of the evaporator section.

In some embodiments, at least a second heat sink is within the second frame member, each of the two condenser sections in heat exchange relationship with a respective one of the heat sink and the at least second heat sink.

In some embodiments, a casing surrounds the battery and at least part of a length of the frame member.

In some embodiments, the casing is thermally insulated.

In some embodiments, the heat sink includes fins disposed within the frame member, the thermal management system includes a flow inducing device operatively connected to the frame member, the flow inducing device operable to induce a flow of a coolant within the frame member.

In some embodiments, the flow inducing device is a fan, the coolant being air or a liquid coolant. In some embodiments, the liquid cooling is a mixture of water and glycol, or water.

In some embodiments, a valve is in fluid communication with an outlet of the casing, the valve having an open configuration in which an interior of the casing is fluidly connected to an environment outside the casing and a closed configuration in which the interior of the casing is fluidly disconnected from the environment outside the casing, the valve being in the open position when the flow inducing device is operational and in the closed position when the flow inducing device is turned off.

In some embodiments, at least one sensor is operatively connected to the casing and a controller, the controller configured to: receive a signal from the at least one sensor, the signal indicative of a temperature within the casing; determine that the temperature is above a first temperature threshold to cool the battery; and power the flow inducing device to induce a flow of the coolant through the frame member.

In some embodiments, at least one sensor is operatively connected to the casing and a controller, the controller configured to: receive a signal from the at least one sensor, the signal indicative of a temperature within the casing; determine that the temperature is below a second temperature threshold to heat the battery; and power the flow inducing device to induce a flow of the coolant through the frame member.

In some embodiments, the heat-conducting plate has an upper casing section facing the battery and a lower casing section facing a volume underneath the electric vehicle, the lower casing section secured to the frame members, the lower casing section increasing a stiffness of the frame.

In accordance with another aspect of the present disclosure, there is also provided a thermal management system for an electric vehicle having a chassis and a battery mounted on a frame of the chassis, comprising: a heat sink located within a cavity of the frame; and a heat-conducting plate having an evaporator section and a condenser section, the evaporator section of the heat-conducting plate being in heat exchange relationship with one of the battery and the heat sink, and the condenser section of the heat-conducting plate being in heat exchange relationship with the other of the battery and the heat sink.

The thermal management system as defined above and described herein may also include any one or more of following features, in whole or in part, and in any combination.

In some embodiments, wherein the heat-conducting plate is U-shaped.

In some embodiments, wherein the condenser section includes two condenser sections protruding from opposite sides of the evaporator section, and wherein the frame includes a frame member and a second frame member spaced apart by a web upon which the battery is mounted, the evaporator section overlapping the web.

In some embodiments, a flow inducing device is operable to induce a flow of a coolant within the cavity of the frame.

### BRIEF DESCRIPTION OF THE DRAWINGS

Reference is now made to the accompanying figures in which:

FIG. 1 is a schematic top view of an electric vehicle in accordance with one embodiment;

FIG. 2 is a top view of a portion of a frame of the electric vehicle of FIG. 1;

FIG. 3A is a cross-sectional view of a portion of the frame of the electric vehicle of FIG. 1 illustrating a thermal management system;

FIG. 3B is a cross-sectional view of a portion of the frame of the electric vehicle of FIG. 1 illustrating a variant of the thermal management system of FIG. 3A;

FIG. 3C is cross-sectional view of a portion of the frame of the electric vehicle of FIG. 1 illustrating a thermal management system in accordance with another embodiment;

FIG. 3D is cross-sectional view of a portion of the frame of the electric vehicle of FIG. 1 illustrating a thermal management system in accordance with another embodiment;

FIG. 3E is cross-sectional view of a portion of the frame of the electric vehicle of FIG. 1 illustrating a thermal management system in accordance with another embodiment;

FIG. 4 is a schematic view illustrating heat paths between battery cells and the frame of the electric vehicle of FIG. 1 with the thermal management system of FIG. 3;

FIG. 5 is a cross-sectional view of a heat-conducting plate secured to the frame of the electric vehicle of FIG. 1 and part of the thermal management system of FIG. 3;

FIG. 6 is a three dimensional view of the portion of the frame of the electric vehicle of FIG. 1 illustrating a first possible cooling scheme;

FIG. 7 is a three dimensional view of the portion of the frame of the electric vehicle of FIG. 1 illustrating a second possible cooling scheme;

FIG. 8 is a three dimensional view of the portion of the frame of the electric vehicle of FIG. 1 illustrating a third possible cooling scheme;

FIG. 9 is a cross-sectional view of a portion of the frame of the electric vehicle of FIG. 1 illustrating a thermal management system in accordance with another embodiment and representing the third possible cooling scheme of FIG. 8;

FIG. 10 is a cross-sectional view of a portion of the frame of the electric vehicle of FIG. 1 illustrating a thermal management system in accordance with another embodiment;

FIG. 11 is a cross-sectional view of a portion of the frame of the electric vehicle of FIG. 1 illustrating a thermal management system in accordance with yet another embodiment;

FIG. 12 is a cross-sectional view illustrating a heat sink in accordance with another embodiment.

### DETAILED DESCRIPTION

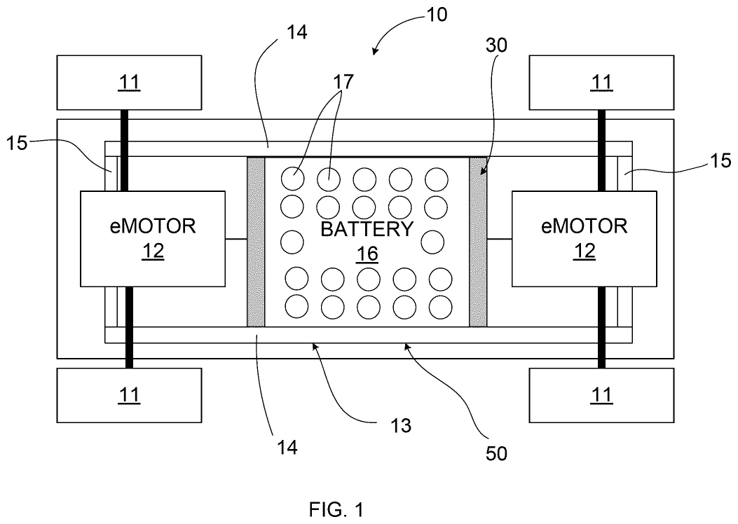

Referring to FIG. 1, an electric vehicle is shown at 10 and includes wheels 11, four in the embodiment shown, that are driven by one or more electric motors 12. In the embodiment shown, the electric motors 12 include a front electric motor driving the front wheels 11 located at the front of the vehicle 10 and a rear electric motor driving the rear wheels 11 located at the rear of the vehicle 10. Other configurations are contemplated. For instance, each of the wheels 11 may be drivingly engaged by a respective electric motor. Thus, for a four-wheel vehicle, four electric motors may be provided. Alternatively, a single electric motor may drive all of the wheels 11, via any suitable transmission.

The vehicle 10 has a chassis 9 that generally includes a frame 13 for supporting the electric motors 12. In the embodiment shown, the frame 13 of the chassis 9 includes longitudinal frame members 14 extending longitudinally between a front and a rear of the vehicle 10, and includes transversal frame members 15 extending transversally between a right side and a left side of the vehicle 10. The frame 13 is depicted here as being generally rectangular, but any other suitable shape may be used. The frame 13 may include truss or any other bracing member to provide the required stiffness to the frame 13 while allowing the frame 13 to sustain the different components of the vehicle 10.

The vehicle 10 includes a battery 16, which may be a Li-ion battery, mounted to the frame 13. The battery 16 maybe, in certain embodiments, be in a cell-to-pack configuration. A conventional battery pack configuration is made up of several modules, each module being composed of multiple cells. Such a cell-to-pack configuration assembles wide and short cells directly into a pack. This may increase a mass and volume integration efficiencies than the conventional pack. In the present embodiment, the battery 16 may be devoid of cell modules. The cells 17 are consequently directly mounted to a battery tray/casing and may be in direct contact with this tray/casing. The cells 17 are depicted here as being cylindrically-shaped, but any other shapes, such as pouch and prismatic, is contemplated without departing from the scope of the present disclosure. The battery 16 thus includes a plurality of cells 17, which are in heat exchange relationship with a thermal management system 50 (which may also be referred to herein as a temperature control system 50) that includes a heat-conducting plate 30. The heat-conducting plate 30 is mounted to the frame 13 and, in the embodiment shown, spans from one of the longitudinal frame members 14 to the other. Other configurations are contemplated. Although the description below makes reference to the longitudinal frame members 14, it will be appreciated that the disclosed thermal management system 50 may leverage any of the frame members of the frame 13 of the vehicle 10, such as the transversal frame members 15 without departing from the scope of the present disclosure.

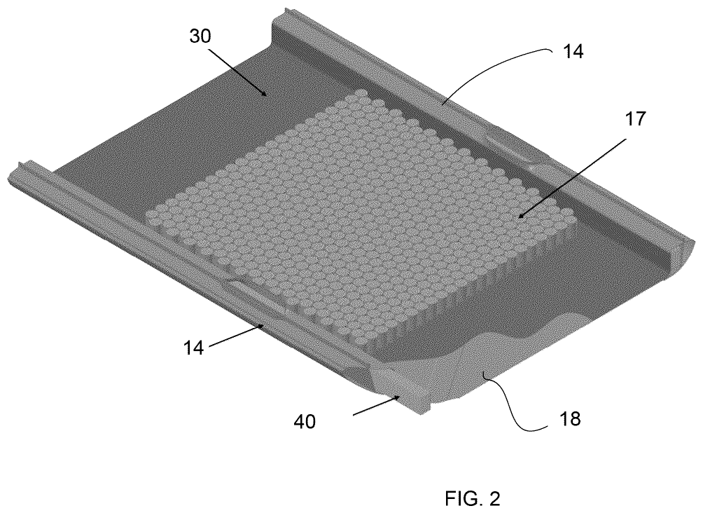

Referring now to FIG. 2, the heat-conducting plate 30 may be supported by a web 18 that spans a space defined between the longitudinal frame members 14. The web 18 may have opposite lateral sides each secured (e.g., welded, bolted) to a respective one of the longitudinal frame members 14. The web 18 may contribute to a structural integrity of the frame 13 of the vehicle 10. In other words, a stiffness of the frame 13 may be increased by the web 18. The web 18 may protect the heat-conducting plate 30 from vibrations, impacts, shocks, chemical effects such as corrosion, and so on. The battery 16 secured to the web 18 may increase a stiffness of the frame 13.

At least one of the longitudinal frame members 14, and in the depicted embodiment both of the longitudinal frame members 14, defines a cavity 7 within which a heat sink 40 is located. The cavity 7 may be partially or fully enclosed by the peripheral wall of the longitudinal frame members 14, when viewed in cross-section. In certain embodiments, one or both ends of the frame members 14 may be open, such as to allow heat transfer communication between the heat sink 40 and the environment or another component of the vehicle via a cooling fluid. The heat sinks 40 may extend longitudinally along a length of the longitudinal frame members 14. The heat sinks 40 may be used to carry heat from the battery 16 away therefore and towards a location being at lower temperature as will be further explained below. The heat sinks 40 may be any suitable device able to move heat. In the present embodiments, the heat sinks 40 include fins. However, in an alternate embodiment, heat pipes may run along the longitudinal frame members 14.

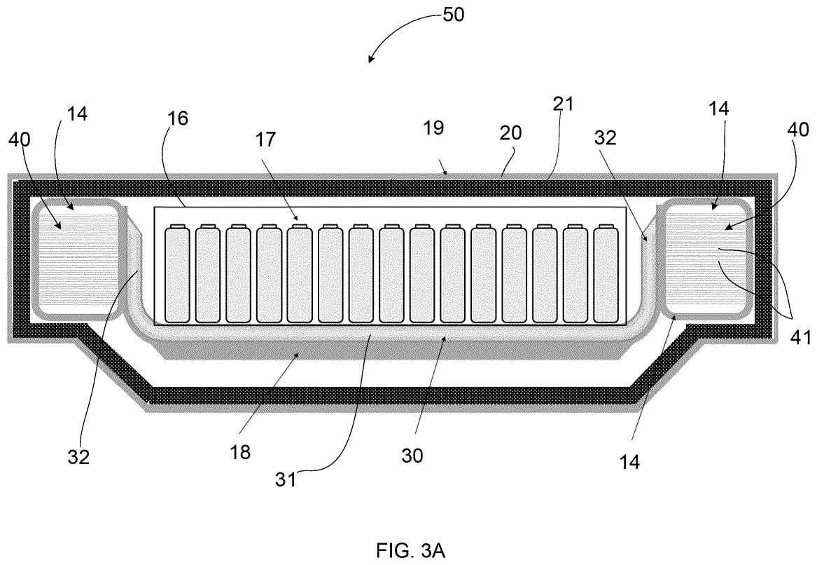

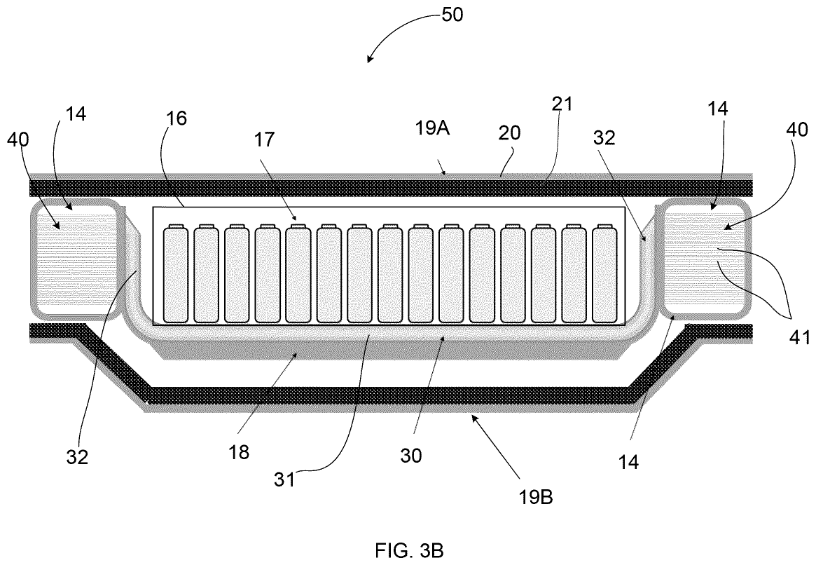

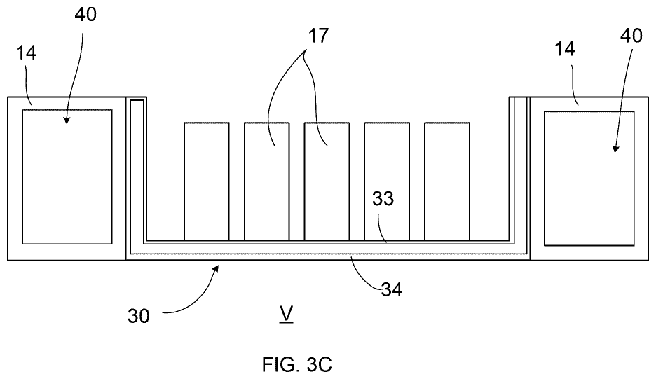

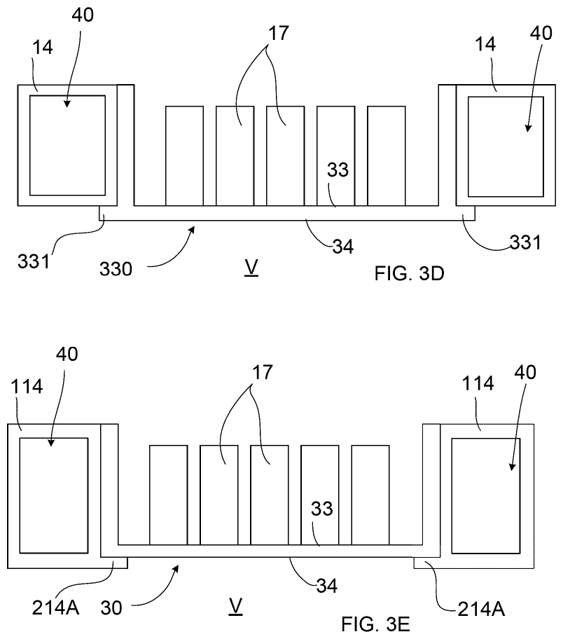

Referring now to FIG. 3A, a more detailed view of the configuration of FIG. 2 is described below. In the embodiment shown, a casing 19 surrounds the battery 16, the heat-conducting plate 30, the web 18, and at least part of the length of the longitudinal frame members 14 that spans the heat-conducting plates 30. The casing 19 may include a rigid outer portion 20 and an insulating layer 21 disposed against an inner face of the rigid outer portion 20. The insulating layer 21 may include any suitable insulating material. The insulating layer 21 may alternatively be located against an outer face of the rigid outer portion 20. The casing 19 may be used to limit loss of thermal energy from the battery 16 in cold weather. The casing 19 may further limit contamination of the air around the cells (e.g., humidity, impurities, etc). Another function of the casing 19 may be to protect the cells 17 against the elements and may protect passengers of the vehicle 10 in case of a battery fire. The casing 19 may be used to secure seats and/or other components of the vehicle 10.

Referring to FIG. 3B, in an alternative embodiment, the casing 19 may be replaced by a top plate 19A. The top plate 19A may be secured to a top face of both of the longitudinal frame members 14 and the transversal frame members 15. An underside of the web 18 may thus be exposed to the environment. The top plate 19A may include an insulating layer 21 against its inner side facing towards the battery 16. In some embodiments, a bottom plate 19B may be provided under the web 18. The bottom plate 19B, as for the top plate 19A, may include an insulating layer on its inner side facing the web 18. The bottom plate 19B may be made of plastic or fiber composite to create an aerodynamically smooth surface under the vehicle 10 and protect the insulation. The bottom plate 19B may further protect the heat-conducting plate 30 from debris (e.g., rocks) under the vehicle 10. Thermal insulation may be applied on side lateral faces of the longitudinal and transversal frame members 14, 15. This thermal insulation may be protected by body panels of the vehicle 10.

As shown in FIGS. 3A and 3B, the heat-conducting plate 30 is U-shape and includes an evaporator section 31 and condenser sections 32. In the present embodiment, the evaporator section 31 is disposed substantially parallel to the web 18. Herein, the expression “substantially”, as in “substantially parallel” is meant to encompass slight variations caused, for instance, by manufacturing tolerances. The evaporator section 31 may be disposed atop the web 18 such that the evaporator section 31 is supported by the web 18. The evaporator section 31 may be in contact with the web 18. The condenser sections 32 herein includes two condenser sections 32 each protruding from a respective side of the evaporator section 31. The condenser sections 32 may therefore be substantially transverse (e.g., perpendicular) to the evaporator section 31. The condenser sections 32 protrude upwardly from the evaporator section 31. In an alternate embodiment, the condenser sections 32 may include only one or more than two condenser sections 32. In alternate embodiments, the heat-conducting plate 30 may have alternate shapes, such as an L-shape, a W-shape, a planar shape, etc.

The evaporator section 31 is in heat exchange contact with the battery 16. More specifically, the cells 17 of the battery 16 may be thermally conductively connected to the evaporator section 31 of the heat-conducting plate 30. A thermal path from the cells 17 to the evaporator section 31 may extend via conduction through a contact interface between the cells 17 and a casing of the battery 16, via conduction through a thickness of the casing or outer shell of the battery 16, and via conduction through a contact interface between the casing of the battery 16 and the evaporator section 31. In some cases, the cells 17 may be in direct abutment against the evaporator section 31 of the heat-conducting plate 30. In such a case, a thermal path from the cells 17 to the evaporator section 31 may extend solely via conduction through a contact interface between the cells 17 and the evaporator section 31. In some embodiments, a thermal adhesive, also referred to as a thermal interface material, or TIM, may be disposed at interfaces between the different components, such as, for instance, between the cells 17 and the casing of the battery 16, to decrease a thermal contact resistance therebetween. A thermal adhesive may be disposed between the cells 17 and the heat-conducting plate 30 to reduce a thermal resistance therebetween. The thermal adhesive may include, for instance, Kapton™ sheet/tape and/or dielectric coating to avoid electrical shortage between the cells and other electrically active materials.

The condenser sections 32 of the heat-conducting plate 30 are in heat exchange relationship with the longitudinal frame members 14 of the frame 13 of the vehicle 10. It will be appreciated that, in an alternate embodiment, the heat-conducting plate 30 may be rotated 90 degrees to be in heat exchange relationship with the transversal frame members 15. As illustrated in FIG. 3, the condenser sections 32 are in contact with the longitudinal frame members 14 such that a thermal path between the condenser sections 32 and the longitudinal frame members 14 extends through a contact interface between the condenser sections 32 and the longitudinal frame members 14. A thermal adhesive may be disposed between the condenser sections 32 and the longitudinal frame members 14 to decrease a thermal contact resistance therebetween.

As mentioned above, the longitudinal frame members 14 may be at least partially hollow. It is to be understood that longitudinal frame members 14 may be formed by any suitable manufacturing process. For example, they may be cast as hollow elements or may be formed by C-shaped or U-shaped channels that are then partially or fully enclosed by an additional element that is fastened (e.g., by welding, or the like) thereto. Regardless of their method of manufacture, the longitudinal frame members 14 will include at least a portion that is hollow, or which has one or more cavities therein, so as to receive the heat sinks 40 as described herein. The heat sinks 40 may be received within the longitudinal frame members 14. In the current embodiment, the heat sinks 40 includes fins 41, which may be made of aluminum, used to dissipate heat to an environment outside the vehicle 10 via convection. Herein, the fins 41 run longitudinally along the longitudinal frame members 14 and are spaced apart vertically. The fins 41 may be oriented substantially horizontally, as shown, or alternately in another direction/orientation (including substantially vertically). A combination of vertical and horizontal fins (e.g., matrix) is also contemplated. More detail about this aspect and other embodiments of the heat sink 40 are presented below. The fins 41 may increase a stiffness of the frame 13. These fins 41 may absorb some of the mechanical energy the frame 13 is subjected to and may assist in limiting deformation of the frame 13. In the depicted embodiment, these fins 41 are depicted in as being plates. It will however be appreciated that, alternatively, the fins may have any other suitable shapes, such as spiral fins. The fins 41 may be made of copper, aluminum, or any other suitable material being sufficiently thermally conductive.

Referring to FIG. 3C, the heat-conducting plate 30 includes an upper casing section 33 facing the cells 17 and a lower casing section 34 opposite the upper casing section 33 and facing a volume V of air underneath the vehicle 10. In this embodiment, the heat-conducting plate 30 acts as a structural frame member. Put differently, the lower casing section 34 of the heat-conducting plate 30 may be sufficiently thick to provide the required stiffness to the frame 13 of the vehicle 10. The lower casing section 34 of the heat-conducting plate 30 may be directly exposed to the volume V of air underneath the vehicle 10. This may avoid a thermal resistance between the heat-conducting plate 30 and the frame 13. The structural function of the web 18 of the frame 13 may be undertaken by the lower casing section 34 of the heat-conducting plate 30. The frame 13 may thus be devoid of the web 18.

In the embodiment of FIG. 3D, the heat-conducting plate 330 defines two tabs 331. Each of those two tabs 331 is in abutment against a respective one of the longitudinal frame members 14. Each of the two tabs 331 may be disposed below a respective one of the longitudinal frame members 14. The two tabs 331 may be used to securely attach the heat-conducting plate 330, which acts as a web of the frame 13, to the longitudinal frame members 14 (or the transversal frame members 15 in an alternate embodiment). In the embodiment of FIG. 3E, the longitudinal frame members 214 define each a tab 214A that extends underneath the heat-conducting plate 30. These tabs 214A may assist in supporting the heat-conducting plate 30, which acts as a web for the frame 13.

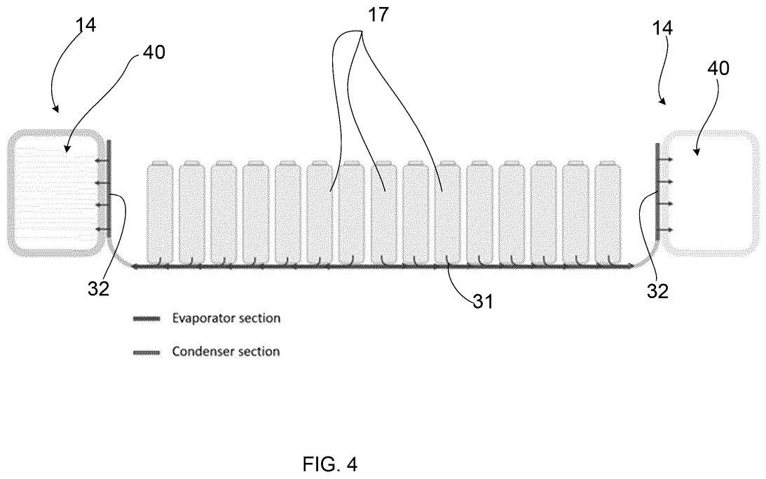

Referring now to FIG. 4, in use, heat generated by the cells 17 of the battery 16 may be absorbed by the evaporator section 31 of the heat-conducting plate 30 and transferred from the evaporator section 31 to the condenser sections 32. At which point, heat may be transferred from the condenser sections 32 to the heat sinks 40 contained inside the longitudinal frame members 14. Heat may then be dissipated in the environment outside the vehicle 10 or to other components within the vehicle requiring heating. The arrows in FIG. 4 illustrate the general direction of heat transfer from the cells 17 to the heat sinks 40. This heat transfer process is entirely passive, and does not require any active steps to be carried out for the excess heat from the batteries to be passively transferred away into the heat-conducting plate 30 and subsequently to the heat sinks 40. When the batteries are cold, the same heat-conducting plate 30 may be used to heat the cells 17. A fluid being at a temperature above that of the batteries may be flown within the frame to transfer heat from this fluid to the frame 13, from the frame 13 to the heat-conducting plate 30, and from the heat-conducting plate 30 to the cells 17.

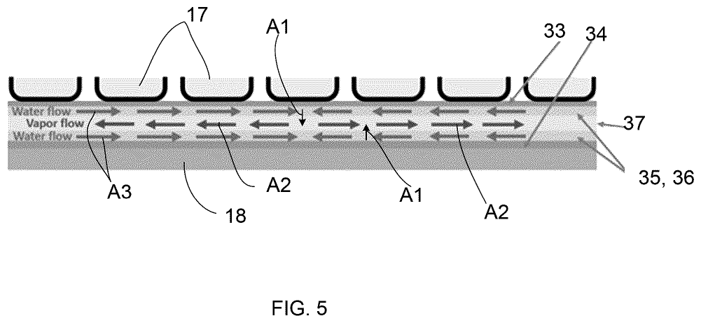

Referring now to FIG. 5, an enlarged cross-sectional view of the heat-conducting plate 30 is illustrated. The heat-conducting plate 30 is operable to move the heat from the evaporator section 31 to the condenser sections 32. The heat-conducting plate 30 includes an upper casing section 33 facing the cells 17 and a lower casing section 34 facing the web 18. Between the upper casing section 33 and the lower casing section 34 are located two wicking layers 35, 36 each disposed adjacent a respective one of the upper casing section 33 and the lower casing section 34. A vapor core 37 is disposed between the two wicking layers 35, 36. The wicking layers 35, 36 may form crossing paths for the vapor such that it can flows in two directions. In an alternate embodiment, a single wicking layer may be provided. This single wicking layer may be located in contact with the upper casing section 33, which is heat exchange relationship with the cells 17.

A thickness of the upper casing section 33 is selected to be as minimal as possible and made of a material having a high thermal conductivity such as copper. However, other materials are possible such as aluminum and polymers. The highly conductive and thin material of the upper casing section 33 may minimize a thermal resistance between the cells 17 and the evaporator section 31 of the heat-conducting plate 30. The lower casing section 34, where it overlaps the web 18, may be made of a material having a high mechanical robustness and high thermal resistance to reduce the loss of thermal energy. The lower casing section 34, where it overlaps the longitudinal frame members 14, should have a low thermal resistance to increase heat transfer. In other words, a portion of the lower casing section 34 that is in heat exchange relationship with the heat sinks 40, and that belongs to the condenser sections 32 of the heat-conducting plate 30, may be made of a material having a high thermal conductivity such as copper.

A working fluid is present in liquid form in the first and second wicking layers 35, 36. This working fluid may be water or any other suitable working fluid able to change phase (e.g., liquid to gaseous) when exposed to the different temperature it is subjected to. When exposed to the heat, the working fluid located in the evaporator section 31 evaporates in a gaseous phase and migrates, along arrows A1, into the vapor core 37. The working fluid in gaseous phase then migrates along arrows A2 along the vapor core 37 towards the condenser section 32 of the heat-conducting plate 30. Since the condenser section 32 is colder than the evaporator section 31, the working fluid condensates back into a liquid phase and gets absorbed by the first and second wicking layers 35, 36. Then, the working fluid moves, by capillary action, along the first and second wicking layers 35, 36 and migrates along arrows A3 back towards the condenser section 32 and the process starts over again. The heat-conducting plate 30 therefore removes heat from the evaporator section 31 by evaporating the working fluid and transfers heat to the condenser sections 32 by condensing the working fluid. These phase changes result in heat being moved from the evaporator section 31 to the condenser sections 32. In an application where the component (i.e. battery) must be heated instead of cooled, then the inverse behavior and direction of the liquid and vapor flows are inverted, without any change to the plate structure. More detail about the heat-conducting plate 31 are presented in U.S. patent application No. 63/290,752 filed on Dec. 17, 2021, the entire contents of which are incorporated herein by reference.

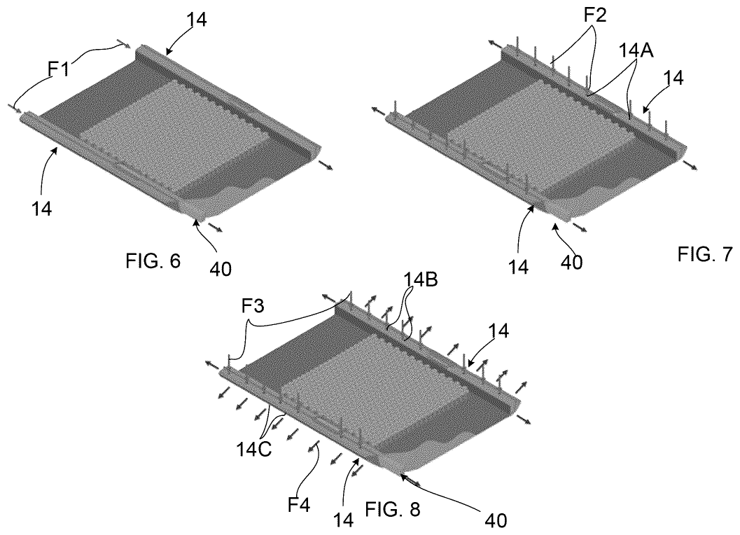

Referring now to FIGS. 6 to 8, three different cooling schemes are presented below for extracting the heat that reaches the longitudinal frame members 14 of frame 13 of the vehicle 10. These cooling schemes may be applicable to any frame members of the frame 13 of the vehicle 10.

In FIG. 6, a longitudinal coolant flow F1 is injected into the longitudinal frame members 14 and flows along a length of the longitudinal frame members 14. In other words, opposite ends of the longitudinal frame members 14 respectively define inlets and outlets for receiving and outputting the longitudinal coolant flow F1. In so doing, heat may be transferred from the fins 41 to the longitudinal coolant flow F1 by convection. Thus, a temperature of the coolant is lower when it enters the heat sink 40 within the longitudinal frame members 14 than when it exits the heat sink 40 since it picked up heat along its passage through the heat sink 40. However, in such a case, a temperature of the cells 17 may increase along a direction of the longitudinal coolant flow F1 since the coolant increases in temperature as it flows along the heat sink 40. The coolant used to flow through the heat sinks 40 may be, for instance, air, a mixture of glycol or other fluid, such as water, or any other suitable coolant. A system including a flow inducing device (e.g., pump, fan, etc) may be used to force the coolant to flow through the heat sinks 40 located within the longitudinal frame members 14. In other words, the vehicle 10 may be equipped with an HVAC system, for heating and cooling a cabin of the vehicle 10; this HVAC system, radiator, or any similar system, may be further used to flow the coolant through the heat sinks 40.

The configuration of FIG. 7 may at least partially improve a temperature uniformity of the cells 17. In this embodiment, transversal coolant flows F2 are injected into the longitudinal frame members 14 and into the heat sinks 40 at a plurality of locations spaced apart from one another along a length of the longitudinal frame members 14. The transversal coolant flows F2 may be injected via apertures 14A defined through the longitudinal frame members 14. These apertures 14A therefore correspond to inlets via which the coolant is received. The transversal coolant flows F2 may then flow longitudinally along the longitudinal frame members 14 and exit via opposite ends of the longitudinal frame members 14. The opposite ends of the longitudinal frame members 14 therefore define outlets for outputting the coolant.

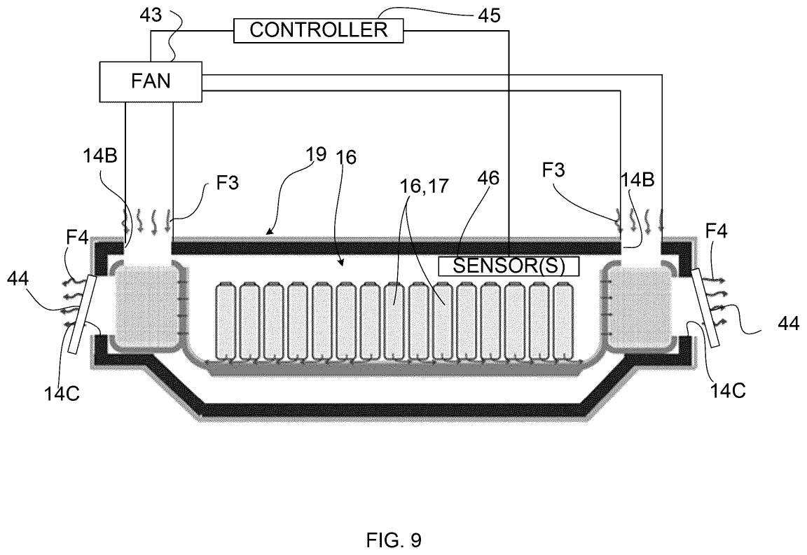

In an alternate embodiment depicted in FIGS. 8-9, the longitudinal frame members 14 define first apertures 14B distributed longitudinally along a length of the longitudinal frame members 14 and second apertures 14C distributed longitudinally along a length of the longitudinal frame members 14. The first apertures 14B may be defined through a top wall of the longitudinal frame members 14 while the second apertures 14C may be defined through a side wall of the longitudinal frame members 14. Other configurations are contemplated. Transversal coolant flows F3 may be injected into the heat sinks 40 via the first apertures 14B, which act as inlets for the coolant. The coolant may exit the heat sinks 40 via the second apertures 14C, which act as outlets for the coolant, and via the opposite ends of the longitudinal frame members. An output coolant flow F4 exits the heat sinks 40 and the longitudinal frame members 14 via the second apertures 14C. This configuration may provide uniform temperature distribution of the cells 17 of the battery 16 along a length of the longitudinal frame members 14.

As illustrated in FIG. 9, a fan 43, which may alternatively be a pump for a liquid coolant, is used to induce a cooling flow that enters the casing 19 that surrounds the battery 16. Valves 44, herein depicted as flaps, may be mounted to the casing 19. The valves 44 may have an open configuration in which an interior of the casing 19 is in fluid flow communication with an environment outside the casing 19 and a closed configuration in which the interior of the casing 19 is fluidly disconnected from the environment outside the casing 19. The valves 44 may move from their closed configuration to their open configuration when the fan 43 is powered. In other words, a pressure of the coolant within the casing 19 may be sufficient to move the valves 44 to their open configurations. The valves 44 may thus be passive devices (e.g., check valves). In an alternate embodiment, the valves 44 may be actuated valves or servo valves operatively to a controller, which may also be operatively connected to the fan 43; the controller operable to power the fan 43 and to move the valves 44 in their open configurations.

The fan 43 may be operatively connected to a controller 45. The controller 45 may have a processing unit and a computer-readable medium having instructions stored thereon executable by the processing unit to cause the processing unit to power the fan 43. The computer-readable medium may be a non-transitory computer-readable medium. The controller 45 may be operatively connected to one or more sensor(s) 46, such as a temperature sensor located within the casing 19. The one or more sensor(s) may provide a signal to the controller 45, the signal indicative of whether a temperature inside the casing 19 is above a first threshold or below a second threshold. The instructions may therefore cause the processing unit to power the fan 43 to flow the coolant within the heat sinks 40 when the temperature is above the first threshold to cool down the battery 16. The instructions may cause the processing unit to stop the fan 43 to stop the flow of the coolant within the heat sinks 40 when the temperature is below the second threshold to heat up the battery 16. The fan 43, controller 45, and sensor 46 may be part of any of the thermal management systems described herein.

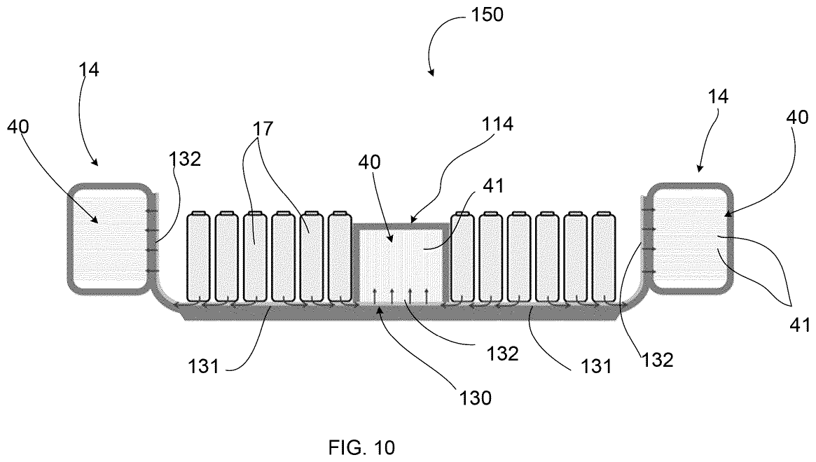

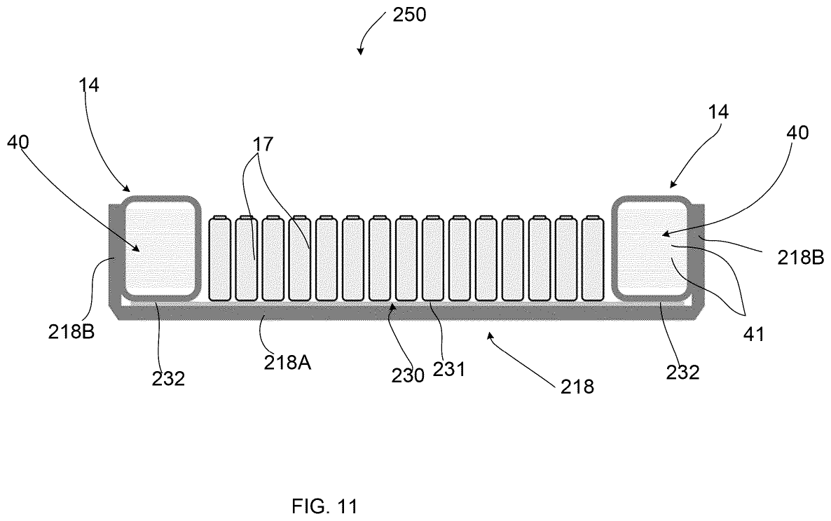

Referring now to FIG. 10, another embodiment of a thermal management system is shown at 150. For the sake of conciseness, only features differing from the thermal management system 50 of FIG. 3 are described below.

In the embodiment shown, the frame 13 includes a longitudinal central frame member 114 that is hollow and includes a heat sink 40, which comprises fins 41 in the present embodiment. Therefore, in this embodiment, the heat-conducting plate 130 includes two evaporator sections 131 and three condenser sections 132. Each of the two evaporators section 131 are located below a respective one of two groups of the cells 17 of the battery 16. Two of the three condenser sections 132 are in heat exchange relationship with the two longitudinal frame members 14 as described above. A third one of the three condenser sections 132 is located between the two groups of the cells 17, between the two evaporator sections 131, and in heat exchange relationship with the longitudinal central frame member 114 of the frame 13 and the heat sink 40 it contains.

Therefore, in this configuration, heat may be extracted from the cells 17 at two different locations and expelled to the environment via three distinct heat sinks 40 each concealed within a respective hollow frame member of the frame 13 of the vehicle 10. This configuration may provide a higher heat flux out of the battery 16 than the configuration of FIG. 3.

Referring now to FIG. 11, another embodiment of a thermal management system is shown at 250. For the sake of conciseness, only features differing from the thermal management system 50 of FIG. 3 are described below.

In the present embodiment, the web 218 includes a central section 218A that spans a distance between the longitudinal frame members 14 and two flanges 218B each protruding vertically from the central section 218A. The longitudinal frame members 14 are located between the two flanges 218B. Thus, each of the longitudinal frame members 14 is located between the cells 17 and a respective one of the two flanges 218B. In an alternate embodiment, the flanges 218B may be parallel to the central section 218A. The flanges 218B may be welded to the central section 218A.

The heat-conducting plate 230 is co-planar and substantially parallel to the central section 218A of the web 218. The heat-conducting plate 230 includes an evaporator section 231 disposed below and in heat exchange relationship with the cells 17. The heat-conducting plate 230 includes two condenser sections 232 each being substantially co-planar with the evaporator section 231 and disposed below and in heat exchange relationship with a respective one of the heat sinks 40 located within the longitudinal frame members 14.

In an alternate embodiment, the flanges 218B may be substantially parallel to the central section 218A, and thereby protrude outwardly slightly relative to the central section 218A. Put differently, the flanges 218B and the central section 218A may be substantially co-planar. In such a case, bottom or top walls of the longitudinal frame members 14 may be secured to the flanges 218B. The longitudinal frame members 14 may be disposed vertically over or below the flanges 218B to overlap the flanges 218B. The longitudinal frame members 14 may be welded to the flanges 218B.

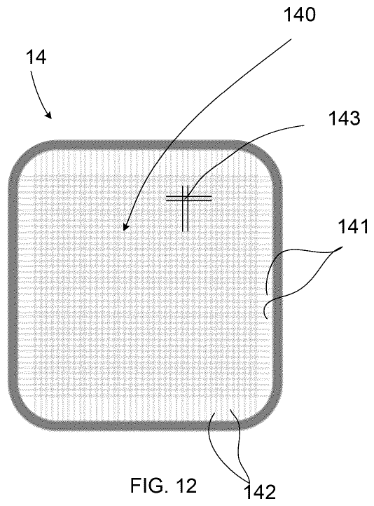

Referring now to FIG. 12, another embodiment of a heat sink is shown at 140. This heat sink 140 may be used with any of the thermal management system 50, 150, 250 described above.

The heat sink 140 includes first fins 141 and second fins 142. The first fins 141 are substantially transverse to the second fins 142. Channels 143 may be defined between the first fins 141 and the second fins 142. These channels 143 may guide the coolant longitudinally along the longitudinal frame members 14.

In the context of the current disclosure, the expression “substantially” is meant to encompass differences imparted by manufacturing tolerances. The expression “about” implies variations of plus or minus 10%.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The terms “connected”, “mounted on” and/or “coupled to”, as used herein, may therefore include both direct coupling (in which two elements that are coupled to each other contact each other) and indirect coupling (in which at least one additional element is located between the two elements).

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. An electric vehicle, comprising:
a chassis including a frame having a frame member, the frame member enclosing a cavity such as to be at least partially hollow;
an electric motor mounted to the frame;
a battery mounted to the frame and operatively connected to the electric motor to provide motive power to the electric vehicle; and
a thermal management system having:
a heat sink located within the cavity of the frame member, and
a heat-conducting plate having an evaporator section and a condenser section, the evaporator section of the heat-conducting plate being in heat exchange relationship with one of the battery and the heat sink, and the condenser section of the heat-conducting plate being in heat exchange relationship with the other of the battery and the heat sink.

2. The electric vehicle of claim 1, wherein the heat-conducting plate is U-shaped.

3. The electric vehicle of claim 1, wherein the frame includes the frame member and a second frame member, and a web connecting the frame member with the second frame member, the battery mounted on the web.

4. The electric vehicle of claim 3, wherein the evaporator section overlaps the web, the condenser section including two condenser sections each protruding from the evaporator section and being disposed adjacent a respective one of the frame member and the second frame member.

5. The electric vehicle of claim 4, wherein the two condenser sections transversally protruding from the evaporator section.

6. The electric vehicle of claim 4, wherein the two condenser sections are parallel to the evaporator section and protrude from opposite sides of the evaporator section.

7. The electric vehicle of claim 4, further comprising at least a second heat sink within the second frame member, each of the two condenser sections in heat exchange relationship with a respective one of the heat sink and the at least second heat sink.

8. The electric vehicle of claim 1, further comprising a casing surrounding the battery and at least part of a length of the frame member.

9. The electric vehicle of claim 8, wherein the casing is thermally insulated.

10. The electric vehicle of claim 8, wherein the heat sink includes fins disposed within the frame member, the thermal management system includes a flow inducing device operatively connected to the frame member, the flow inducing device operable to induce a flow of a coolant within the frame member.

11. The electric vehicle of claim 10, wherein the flow inducing device is a fan, the coolant being air or a liquid coolant.

12. The electric vehicle of claim 11, wherein the liquid cooling is a mixture of water and glycol, or water.

13. The electric vehicle of claim 10, further comprising a valve in fluid communication with an outlet of the casing, the valve having an open configuration in which an interior of the casing is fluidly connected to an environment outside the casing and a closed configuration in which the interior of the casing is fluidly disconnected from the environment outside the casing, the valve being in the open position when the flow inducing device is operational and in the closed position when the flow inducing device is turned off.

14. The electric vehicle of claim 10, further comprising at least one sensor operatively connected to the casing and a controller, the controller configured to:
receive a signal from the at least one sensor, the signal indicative of a temperature within the casing;
determine that the temperature is above a first temperature threshold to cool the battery; and
power the flow inducing device to induce a flow of the coolant through the frame member.

15. The electric vehicle of claim 10, comprising at least one sensor operatively connected to the casing and a controller, the controller configured to:
receive a signal from the at least one sensor, the signal indicative of a temperature within the casing;
determine that the temperature is below a second temperature threshold to heat the battery; and
power the flow inducing device to induce a flow of the coolant through the frame member.

16. The electric vehicle of claim 1, wherein the heat-conducting plate has an upper casing section facing the battery and a lower casing section facing a volume underneath the electric vehicle, the lower casing section secured to the frame member, the lower casing section increasing a stiffness of the frame.

17. A thermal management system for an electric vehicle having a chassis and a battery mounted on a frame of the chassis, comprising:
a heat sink located within a cavity of the frame; and
a heat-conducting plate having an evaporator section and a condenser section, the evaporator section of the heat-conducting plate being in heat exchange relationship with one of the battery and the heat sink, and the condenser section of the heat-conducting plate being in heat exchange relationship with the other of the battery and the heat sink.

18. The thermal management system of claim 17, wherein the heat-conducting plate is U-shaped.

19. The thermal management system of claim 18, wherein the condenser section includes two condenser sections protruding from opposite sides of the evaporator section, and wherein the frame includes a frame member and a second frame member spaced apart by a web upon which the battery is mounted, the evaporator section overlapping the web.

20. The thermal management system of claim 17, further comprising a flow inducing device operable to induce a flow of a coolant within the cavity of the frame.
